(19) United States
(12) Patent Application Publication
(10) Pub. No.: US 2026/0171701 A1
(43) Pub. Date: Jun. 18, 2026

(54) Plug-Type Printed Circuit Board Cable Assembly and Plug-Type Printed Circuit Board

(71) Applicant: INNODISK CORPORATION, NEW TAIPEI CITY (TW)

(72) Inventor: CHIH-CHIEH KAO, NEW TAIPEI CITY (TW)

(73) Assignee: INNODISK CORPORATION, NEW TAIPEI CITY (TW)

(21) Appl. No.: 19/271,173

(22) Filed: Jul. 16, 2025

(30) Foreign Application Priority Data
Dec. 18, 2024 (TW) 113149458

(51) Int. Cl. H01R 12/77

(52) U.S. Cl. CPC H01R 12/777

(57) ABSTRACT

A plug-type printed circuit board cable assembly includes a plug-type printed circuit board and a set of wires. The plug-type printed circuit board includes a plug-type connection section, a wiring section and an impedance control section. The plug-type connection section is disposed on a first end of the plug-type printed circuit board and has connection portion contacts, wherein a thickness of the plug-type connection section is adapted to allow the plug-type connection section to be inserted into an external interface. The wiring section is disposed on a second end of the plug-type printed circuit board and has wiring portion contacts and a ground/power zone. The impedance control section has a set of traces electrically connected between the connection portion contacts and the wiring portion contacts to achieve impedance matching between the connection portion contacts and the wiring portion contacts. The set of wires are connected to the wiring portion.

### CROSS REFERENCE TO RELATED APPLICATIONS

This application claims the benefit of Taiwan Patent Application No. 113149458, filed on December 18, 2024, at the Taiwan Intellectual Property Office, the disclosures of which are incorporated herein in their entirety by reference.

### FIELD OF THE INVENTION

The present invention relates to a plug-type printed circuit board cable assembly, particularly a plug-type printed circuit board cable assembly whose pin count and pin assignment are adjustable.

### BACKGROUND OF THE INVENTION

Currently, the board-to-board connectors used in the market do not have a unified pin assignment, pin header, or plug form. Traditionally, the commonly used flexible flat cable (FFC) plug has the advantages of being flat, lightweight, and easy to install. The FFC plug is often used to connect internal components, such as motherboards and displays. However, the FFC plug is a single-layer structure and cannot support multi-layer traces or through-holes, which limits its application range. As for the cable, a fixed parallel wire structure that cannot be bent into complex shapes is used, only allowing parallel circuit connections with limited design flexibility. In addition, the FFC cannot achieve precise impedance control, which will affect signal quality in high-frequency signal transmissions.

Another common connector is the flexible printed circuit (FPC) plug, which is highly flexible and lightweight, making it suitable for miniaturized and flexible applications. The FPC can be a multi-layer structure, supporting jumper connections and wiring according to different pins. The manufacturing process of the FPC includes steps such as photosensitization and etching, which is similar to traditional PCB processes. However, when multi-layer designs or complex traces are required, the manufacturing and design costs of the FPC are relatively high. Since complex processes, involving wiring design and manufacturing, are required for the FPC completion, the costs of modifications and redesigns will be increased, and the production time will become longer. Additionally, the FPC production typically has a minimum order quantity (MOQ) requirement, which makes it less economical for small-batch or customized production.

The aforementioned drawbacks make the traditional FFC plugs and the FPC plugs insufficient for applications that require higher design flexibility, shorter production cycles, or better cost-performance ratios.

Therefore, there is an urgent need for a plug-type printed circuit board cable assembly that can adjust the number of pins and the pin assignment to overcome the aforementioned issues.

### SUMMARY OF THE INVENTION

One objective of the present invention is to provide a plug-type printed circuit board cable assembly to increase the flexibility of applications by designing a plug-type printed circuit board cable with flexible adjustment of the number of pins, the pin assignment, and the jumper connections.

Another objective of the present invention is to provide a plug-type printed circuit board and a plug-type printed circuit board cable assembly to improve the signal quality of high-frequency signal transmission by designing an impedance control region.

In accordance with one aspect of the present disclosure, a plug-type printed circuit board cable assembly is disclosed. The plug-type printed circuit board cable assembly includes a plug-type printed circuit board and a set of wires. The plug-type printed circuit board includes: a plug-type connection portion, a wiring portion and an impedance control region. The plug-type connection portion is disposed on a first end of the plug-type printed circuit board having a plurality of connection portion contacts, wherein the plug-type connection portion has a thickness adapted to allow the plug-type connection portion to be inserted into an external interface. The wiring portion is disposed on a second end of the plug-type printed circuit board having a plurality of wiring portion contacts and a ground/power zone. The impedance control region has a set of traces electrically connected between the plurality of connection portion contacts and the plurality of wiring portion contacts to achieve impedance matching between the plurality of connection portion contacts and the plurality of wiring portion contacts. The set of wires is connected to the wiring portion.

In accordance with one more aspect of the present disclosure, a plug-type printed circuit board cable assembly is disclosed. The plug-type printed circuit board cable assembly includes a first plug-type printed circuit board and a second plug-type printed circuit board. The first plug-type printed circuit board includes a first wiring portion disposed on one end of the first plug-type printed circuit board and having a plurality of first wiring portion contacts. The second plug-type printed circuit board includes a second wiring portion disposed on one end of the second plug-type printed circuit board having a plurality of second wiring portion contacts; and a set of wires connected to the plurality of first wiring portion contacts on the first plug-type printed circuit board and the plurality of second wiring portion contacts on the second plug-type printed circuit board in a customized contact configuration relationship.

In accordance with one more aspect of the present disclosure, a plug-type printed circuit board is disclosed. The plug-type printed circuit board includes a plug-type connection portion, a wiring portion and an impedance control region. The plug-type connection portion is disposed on a first end of the plug-type printed circuit board, and the plug-type connection portion includes a plurality of connection portion contacts, wherein the plug-type connection portion has a thickness adapted to allow the plug-type connection portion to be inserted into an external interface. The wiring portion is disposed on a second end of the plug-type printed circuit board, and the wiring portion includes a plurality of wiring portion contacts and a ground/power zone configured to be connected to a set of wires. The impedance control region includes a set of traces electrically connected between the plurality of connection portion contacts and the plurality of wiring portion contacts to achieve impedance matching between the plurality of connection portion contacts and the plurality of wiring portion contacts.

The above objectives and advantages of the present invention will become more readily apparent to those ordinarily skilled in the art after reviewing the following detailed descriptions.

### BRIEF DESCRIPTION OF THE DRAWINGS

Other objectives, advantages and efficacies of the present invention will be described in detail below taken from the preferred embodiments with reference to the accompanying drawings.

FIG. 1 is a top view of a plug-type printed circuit board cable assembly according to an embodiment of the present invention.

FIG. 2 is a top view of a plug-type printed circuit board according to another embodiment of the present invention.

FIG. 3 is a top view of a plug-type printed circuit board according to another embodiment of the present invention.

FIG. 4(A) to FIG. 4(F) are top views of plug-type printed circuit boards according to other embodiments of the present invention.

FIG. 5 is a top view of a plug-type printed circuit board cable assembly according to another embodiment of the present invention.

### DETAILED DESCRIPTION OF THE PREFERRED EMBODIMENTS

The present invention will now be described more specifically with reference to the following embodiments. It is to be noted that the following descriptions of preferred embodiments of this invention are presented herein for purpose of illustration and description only; they are not intended to be exhaustive or to be limited to the precise form disclosed. In the preferred embodiments, the same reference numeral represents the same element in each embodiment.

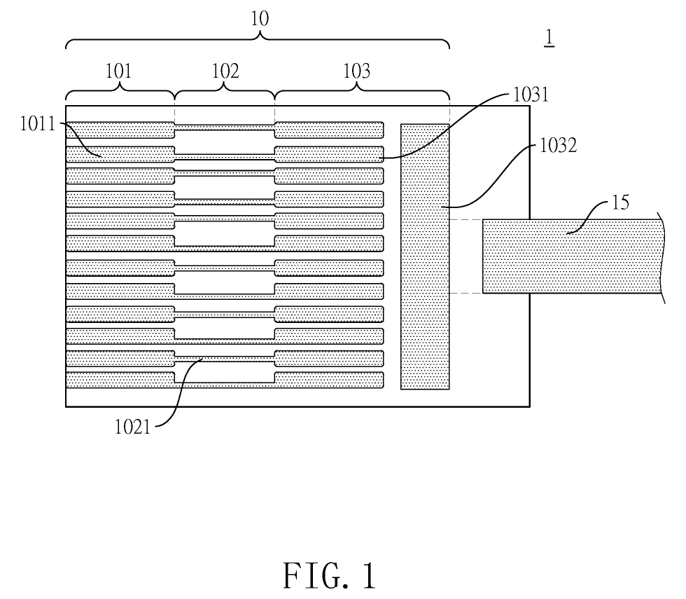

Please refer to FIG. 1, which is a top view of a plug-type printed circuit board (PCB) cable assembly according to an embodiment of the present invention. In FIG. 1, the plug-type printed circuit board cable assembly 1 of the present invention includes a plug-type printed circuit board 10 and a set of wires 15. The plug-type printed circuit board 10 includes a plug-type connection portion 101, a wiring portion 103 and an impedance control region102.

The plug-type connection portion 101 is disposed on one end of the plug-type printed circuit board 10, and the plug-type connection portion 101 has a plurality of connection portion contacts 1011. The plug-type connection portion 101 has a thickness adapted to allow the plug-type connection portion 101 to be inserted into an external interface (not shown). The connection portion contacts 1011 can be made of copper, tin, tin-copper alloy, gold, silver, or other conductors with good electrical conductivity. Preferably, surfaces of the connection portion contacts 1011 can be gold-plated or palladium-plated to provide excellent properties of conductivity, corrosion resistance and oxidation resistance, thereby extending the lifespan of the plug-type connection portion 101. In addition, the thickness and the width of the connection portion contacts 1011 can be adjusted according to design requirements to accommodate different current loads and impedance matching needs. In an embodiment, the thickness of the plug-type connection portion 101 is approximately 0.3 mm, so as to be suitable for being inserted into the external interface to form a clamping relationship. In some embodiments, the external interface can be a mobile industry processor interface (MIPI), a universal serial bus (USB) interface, or a low-voltage differential signaling (LVDS) interface or other interfaces. Therefore, the plurality of connection portion contacts 1011 of the plug-type connection portion 101 may be arranged in parallel with equal spacing, and the number of contacts, the contact pitch and the pin assignment may be configured according to actual needs, which are not limited by the present invention.

The wiring portion 103 is disposed on the other end of the plug-type printed circuit board 10, and the wiring portion 103 has a plurality of wiring portion contacts 1031 and a ground/power zone 1032 for connecting the set of wires 15. In an embodiment, the wiring portion contacts 1031 and the ground/power zone 1032 can be made of copper, tin, tin-copper alloy, gold, silver, or other conductors with good electrical conductivity. In addition, the thickness and the width of the wiring portion contacts 1031 and the ground/power zone 1032 can be adjusted according to design requirements to accommodate different current loads and impedance matching needs. The set of wires 15 and the wiring portion 103 are connected using jumper connections according to actual needs. In an embodiment, the set of wires 15 can be formed by a plurality of single-core wires or coaxial cables with good flexibility and conductivity. In an embodiment, the set of wires 15 can be enclosed by, for example, an insulating tape or a rubber covering layer (not shown) to improve the durability and the anti-interference capabilities.

The impedance control region 102 has a set of traces 1021 electrically connected between the plurality of connection portion contacts 1011 and the plurality of wiring portion contacts 1031 to achieve impedance matching between the plurality of connection portion contacts 1011 and the plurality of wiring portion contacts 1031. In an embodiment, the impedance matching between the plurality of connection portion contacts 1011 and the plurality of wiring portion contacts 1031 can be controlled by adjusting the geometry of the material, the length, the width and the thickness of the set of traces 1021, which is beneficial to improving the signal quality during the high-frequency transmission.

Additionally, in some embodiments, the plurality of connection portion contacts 1011, the plurality of wiring portion contacts 1031 and the set of traces 1021 can be disposed on either one or both surfaces of the plug-type printed circuit board 10. In other words, the plug-type printed circuit board 10 of the present invention can provide a connection with upper contacts and/or lower contacts to avoid connection failure due to contact surface errors. This ensures that both the front and back sides can be correctly connected, which can increase the flexibility of the application of the present invention.

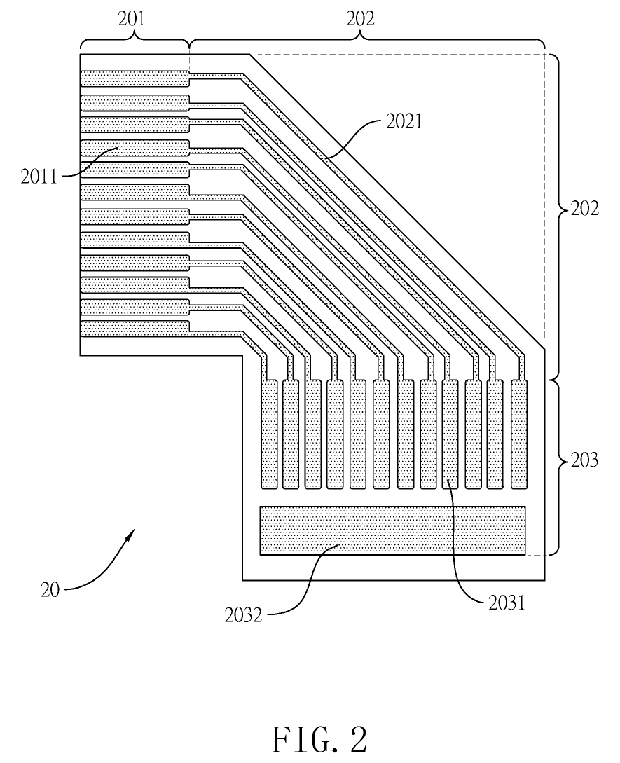

FIG. 2 is a top view of a plug-type printed circuit board according to another embodiment of the present invention. Similar to the plug-type printed circuit board 10 in FIG. 1, the plug-type printed circuit board 20 in FIG. 2 includes a plug-type connection portion 201, a wiring portion 203 and an impedance control region 202. The plug-type connection portion 201 is disposed on one end of the plug-type printed circuit board 20, and the plug-type connection portion 201 has a plurality of connection portion contacts 2011. The wiring portion 203 is disposed on the other end of the plug-type printed circuit board 20, and the wiring portion 203 has a plurality of wiring portion contacts 2031 and a ground/power zone 2032. The impedance control region 202 has a set of traces 2021 electrically connected between the plurality of connection portion contacts 2011 and the plurality of wiring portion contacts 2031 to achieve impedance matching between the plurality of connection portion contacts 2011 and the plurality of wiring portion contacts 2031. However, the difference from the plug-type printed circuit board 10 in FIG. 1 is that the impedance control region 202 of the plug-type printed circuit board 20 in FIG. 2 has a bending angle, causing the plug-type connection portion 201 and the wiring portion 203 to have different orientations. Specifically, the impedance matching between the plurality of connection portion contacts 2011 and the plurality of wiring portion contacts 2031 can be controlled by more flexibly adjusting the geometry of the material, the length, the width and the thickness of the set of traces 2021, which is beneficial to improving the signal quality during the high-frequency transmission.

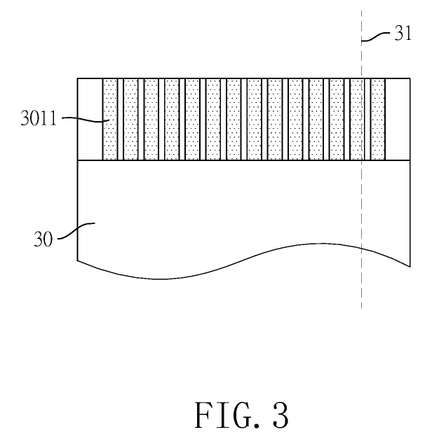

As mentioned above, the number of contacts, the contact pitch and the pin assignment on the plug-type printed circuit board of the present invention may be configured according to actual needs. FIG. 3 is a top view of a plug-type printed circuit board according to another embodiment of the present invention. In FIG. 3, the plug-type printed circuit board 30 includes, for example, 40 contacts 3011. In this embodiment, the plug-type printed circuit board 30 is a trimmable structure. The user can trim the plug-type printed circuit board 30 along a trimming line 31 shown in FIG. 3, thereby adjusting the number of contacts. For instance, if a specific application requires only 25 contacts, the user can trim the excess portion to better suit the application requirements, avoiding waste and increasing cost-effectiveness. Such an adjustable design significantly enhances the versatility of the plug-type printed circuit board 30, and can meet both the requirements of high contact density and the application of a lower number of contacts.

During the trimming process, CNC (Computer Numerical Control) technology can be used with a milling cutter to perform precise trimming along the trimming line 31 shown in FIG. 3. The characteristics of the milling cutter are its high hardness and sharp cutting edges, which ensure clean and smooth edges when cutting PCB materials, to prevent the delamination or cracking of the material. Depending on the requirements, milling cutters with different diameters and numbers of cutting edges can be selected to achieve the best cutting results.

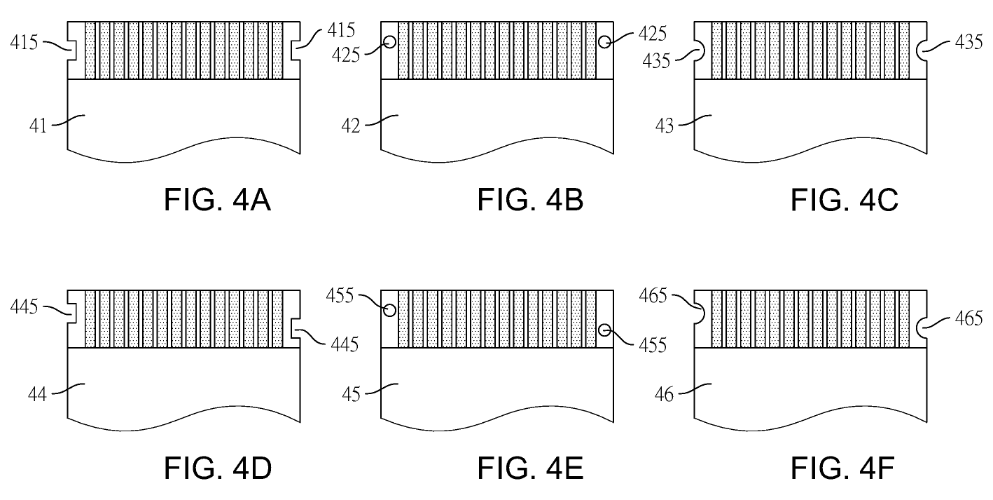

The appearance of the plug-type printed circuit board of the present invention is not limited to the plug-type printed circuit board 10 in FIG. 1. In order to increase fixation and prevent detachment, the plug-type printed circuit boards according to other embodiments of the present invention may have different structural variations on the sides. For example, in FIG. 4(A), the sides of the plug-type printed circuit board 41 have symmetrical barbs 415; in FIG. 4(B), the sides of the plug-type printed circuit board 42 have symmetrical holes 425; in FIG. 4(C), the sides of the plug-type printed circuit board 43 have symmetrical protrusions 435; in FIG. 4(D), the sides of the plug-type printed circuit board 44 have asymmetrical barbs 445; in FIG. 4(E), the sides of the plug-type printed circuit board 45 have asymmetrical holes 455; and in FIG. 4(F), the sides of the plug-type printed circuit board 46 have asymmetrical protrusions 465. However, the present invention is not limited to these specific examples. Any skilled person in the art may make slight modifications or substitutions without departing from the spirit and scope of the present invention.

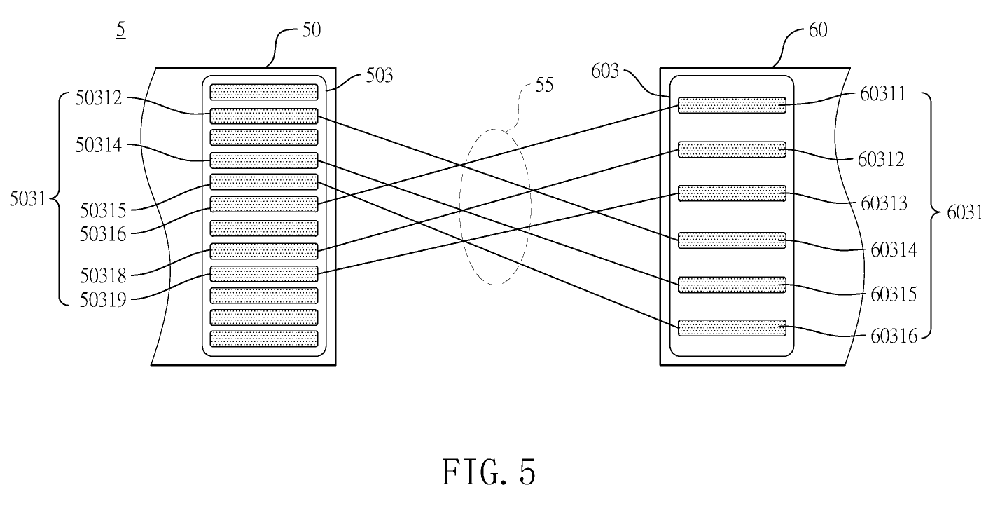

FIG. 5 is a top view of a plug-type printed circuit board cable assembly according to another embodiment of the present invention. In FIG. 5, the plug-type printed circuit board cable assembly 5 includes a first plug-type printed circuit board 50 and a second plug-type printed circuit board 60. A plurality of wiring portion contacts 5031 of a wiring portion 503 of the first plug-type printed circuit board 50 are connected to a plurality of wiring portion contacts 6031 of a wiring portion 603 of the second plug-type printed circuit board 60 by a set of wires 55. In an embodiment, the number of wiring portion contacts 5031 of the wiring portion 503 of the first plug-type printed circuit board 50 may not necessarily be the same as the number of wiring portion contacts 6031 of the wiring portion 603 of the second plug-type printed circuit board 60. The configuration of the contacts on both first plug-type printed circuit board 50 and second plug-type printed circuit board 60 may also differ, allowing the set of wires 55 to connect the plurality of wiring portion contacts 5031 and the plurality of wiring portion contacts 6031 in a customized contact configuration relationship. In an embodiment, the set of wires 55 can be formed by a plurality of single-core wires or coaxial cables with good flexibility and conductivity. For example, as shown in FIG. 5, the wiring portion contact 50312 is connected to the wiring portion contact 60314 through the set of wires 55; the wiring portion contact 50314 is connected to the wiring portion contact 60315 through the set of wires 55; the wiring portion contact 50315 is connected to the wiring portion contact 60316 through the set of wires 55; the wiring portion contact 50316 is connected to the wiring portion contact 60311 through the set of wires 55; the wiring portion contact 50318 is connected to the wiring portion contact 60312 through the set of wires 55; and the wiring portion contact 50319 is connected to the wiring portion contact 60313 through the set of wires 55. The contact configuration relationship above can be customized by the user according to the specific requirements of the application. In an embodiment, the set of wires 55 can be enclosed by, for example, an insulating tape or a rubber covering layer (not shown) to improve the durability and the anti-interference capabilities.

In the above embodiments, the plug-type printed circuit board cable assembly of the present invention features the ability to flexibly adjust the number of pins and the structure of the intermediate cable. The number of contacts in the plug-type connection portion can be adjusted according to the actual needs, and the structure of the intermediate cable can be altered by replacing or re-wiring to meet different specification requirements. The present invention not only reduces production costs but also improves the flexibility and adaptability of the product.

Although the present invention has been described with reference to certain exemplary embodiments thereof, it can be understood by those skilled in the art that a variety of modifications and variations may be made to the present invention without departing from the spirit or scope of the present invention defined in the appended claims, and their equivalents.

What is claimed is:

1. A plug-type printed circuit board cable assembly, comprising:
a plug-type printed circuit board, including:
a plug-type connection portion disposed on a first end of the plug-type printed circuit board and having a plurality of connection portion contacts, wherein the plug-type connection portion has a thickness adapted to allow the plug-type connection portion to be inserted into an external interface;
a wiring portion disposed on a second end of the plug-type printed circuit board and having a plurality of wiring portion contacts and a ground/power zone; and
an impedance control region having a set of traces electrically connected between the plurality of connection portion contacts and the plurality of wiring portion contacts to achieve impedance matching between the plurality of connection portion contacts and the plurality of wiring portion contacts; and
a set of wires connected to the wiring portion.

2. The plug-type printed circuit board cable assembly as claimed in claim 1, wherein the plurality of connection portion contacts, the plurality of wiring portion contacts and the set of traces are disposed on either one or both surfaces of the plug-type printed circuit board.

3. The plug-type printed circuit board cable assembly as claimed in claim 1, wherein the thickness is approximately 0.3 mm.

4. The plug-type printed circuit board cable assembly as claimed in claim 1, further comprising a covering layer configured to enclose the set of wires, wherein the set of wires comprises a plurality of single-core wires or coaxial cables, and the wiring portion and the set of wires are connected using jumper connections.

5. The plug-type printed circuit board cable assembly as claimed in claim 1, wherein the plug-type printed circuit board is trimmable, allowing the number of connection portion contacts to be adjusted.

6. The plug-type printed circuit board cable assembly as claimed in claim 1, wherein the impedance control region has a bending angle, causing the plug-type connection portion and the wiring portion to have different orientations.

7. A plug-type printed circuit board cable assembly, comprising:
a first plug-type printed circuit board, including:
a first wiring portion disposed on one end of the first plug-type printed circuit board and having a plurality of first wiring portion contacts; and
a second plug-type printed circuit board, including:
a second wiring portion disposed on one end of the second plug-type printed circuit board and having a plurality of second wiring portion contacts; and
a set of wires connected to the plurality of first wiring portion contacts on the first plug-type printed circuit board and the plurality of second wiring portion contacts on the second plug-type printed circuit board in a customized contact configuration relationship.

8. The plug-type printed circuit board cable assembly as claimed in claim 7, wherein:
the first plug-type printed circuit board further comprises:
a first plug-type connection portion disposed on the other end of the first plug-type printed circuit board and having a plurality of first connection portion contacts, wherein the first plug-type connection portion has a first thickness adapted to allow the first plug-type connection portion to be inserted into a first external interface; and
a first impedance control region having a set of first traces electrically connected between the plurality of first connection portion contacts and the plurality of first wiring portion contacts to achieve impedance matching between the plurality of first connection portion contacts and the plurality of first wiring portion contacts; and
the second plug-type printed circuit board further comprises:
a second plug-type connection portion disposed on the other end of the second plug-type printed circuit board and having a plurality of second connection portion contacts, wherein the second plug-type connection portion has a second thickness adapted to allow the second plug-type connection portion to be inserted into a second external interface; and
a second impedance control region having a set of second traces electrically connected between the plurality of second connection portion contacts and the plurality of second wiring portion contacts to achieve impedance matching between the plurality of second connection portion contacts and the plurality of second wiring portion contacts.

9. The plug-type printed circuit board cable assembly as claimed in claim 7, further comprising a covering layer configured to enclose the set of wires, wherein the set of wires comprises a plurality of single-core wires or coaxial cables, and the first wiring portion, the second wiring portion and the set of wires are connected using jumper connections.

10. The plug-type printed circuit board cable assembly as claimed in claim 8, wherein the plurality of first connection portion contacts, the plurality of first wiring portion contacts and the set of first traces are disposed on both surfaces of the first plug-type printed circuit board.

11. The plug-type printed circuit board cable assembly as claimed in claim 10, wherein the plurality of second connection portion contacts, the plurality of second wiring portion contacts and the set of second traces are disposed on both surfaces of the second plug-type printed circuit board.

12. The plug-type printed circuit board cable assembly as claimed in claim 8, wherein the first thickness and the second thickness are approximately 0.3 mm.

13. The plug-type printed circuit board cable assembly as claimed in claim 8, wherein the first plug-type printed circuit board is trimmable, allowing the number of first connection portion to be adjustable.

14. The plug-type printed circuit board cable assembly as claimed in claim 13, wherein the second plug-type printed circuit board is trimmable, allowing the number of second connection portion to be adjustable.

15. The plug-type printed circuit board cable assembly as claimed in claim 8, wherein the first impedance control region has a first bending angle, causing the first plug-type connection portion and the first wiring portion to have different orientations.

16. The plug-type printed circuit board cable assembly as claimed in claim 15, wherein the second impedance control region has a second bending angle, causing the second plug-type connection portion and the second wiring portion to have different orientations.

17. A plug-type printed circuit board, comprising:
a plug-type connection portion disposed on a first end of the plug-type printed circuit board and comprising a plurality of connection portion contacts, wherein the plug-type connection portion has a thickness adapted to allow the plug-type connection portion to be inserted into an external interface;
a wiring portion disposed on a second end of the plug-type printed circuit board and comprising a plurality of wiring portion contacts and a ground/power zone configured to be connected to a set of wires; and
an impedance control region comprising a set of traces electrically connected between the plurality of connection portion contacts and the plurality of wiring portion contacts to achieve impedance matching between the plurality of connection portion contacts and the plurality of wiring portion contacts.

18. The plug-type printed circuit board as claimed in claim 17, wherein the plurality of connection portion contacts, the plurality of wiring portion contacts and the set of traces are disposed on either one or both surfaces of the plug-type printed circuit board.

19. The plug-type printed circuit board as claimed in claim 17, wherein the impedance control region has a bending angle, causing the plug-type connection portion and the wiring portion to have different orientations, and the wiring portion and the set of wires are connected using jumper connections.

20. The plug-type printed circuit board as claimed in claim 17, further comprising a covering layer configured to enclose the set of wires, wherein the set of wires comprises a plurality of single-core wires or coaxial cables, and the wiring portion and the set of wires are connected using jumper connections.
